(19) United States
(12) Patent Application Publication
(10) Pub. No.: US 2006/0058471 A1
(43) Pub. Date: Mar. 16, 2006

(54) Slush molded elastomeric layer

(76) Inventor: Peter L. Szekely, Pingy (FR)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/225,347

(22) Filed: Sep. 13, 2005

Related U.S. Application Data
(60) Provisional application No. 60/610,455, filed on Sep. 16, 2004.

(51) Int. Cl. C08L 83/04; B29C 41/18

(52) U.S. Cl. 525/474; 525/477; 264/302

(57) ABSTRACT

A slush molded elastomeric layer is provided comprised of copolyether ester elastomer as a major component, a first siloxane from the group of carboxy-functional polysiloxanes and alkyl aryl polysiloxanes, a second siloxane that is different from the first siloxane and from the group of a high molecular weight polysiloxanes, carboxy-functional polysiloxanes and alkyl aryl polysiloxanes, and an antioxidant.

### CROSS REFERENCE TO RELATED APPLICATIONS

This application claims the benefit of U.S. Provisional Application No. 60/610,455, filed Sep. 16, 2004.

### BACKGROUND OF THE INVENTION

1. Field of the Invention

This invention relates to slush molded layers or shells formed from thermoplastic copolyester elastomer compositions. The copolyester elastomer slush molded layers exhibit excellent physical properties and in particular good abrasion and scratch resistance. The slush molded layers can be incorporated into laminate structures that may be used in motor vehicle interior parts such as dashboards.

2. Description of the Related Art

Slush molding is a process for forming relatively thin thermoplastic layers or shells that are put to various uses including use as the exterior layer of automotive dashboards and other automotive interior panels. In the slush molding process, a mold for a layer or article to be formed is preheated to a temperature sufficient to melt the thermoplastic resin being molded. The mold is then connected to a box containing thermoplastic resin in the form of a powder or micro pellets with a particle size that is generally below 1200 μm. The assembly of box and mold is put under rotation in order to disperse the particles over the hot surface of the mold. The thermoplastic resin powder or micro pellets that are near the heated mold surface melt to form a layer or skin over the mold surface. Excess resin powder or micro pellets can be removed from the mold. The mold may be reheated to complete the formation of a homogeneous layer. The mold is then cooled or quenched with water and/or air during which the thermoplastic material solidifies. The solidified thermoplastic layer is subsequently removed from the mold. This slush molding process is also sometimes referred to as powder slush moulding or slush casting.

Slush-molded layers or shells may be used as freestanding films or sheets, or they may be used as a layer in a laminated structure. Where the slush molded layer is to be used as an outer skin layer of a laminate structure, a textured mold may be used in order to obtain an outer skin with a textured or embossed surface. The tensile properties of a polymer material may differ when processed by slush molding as compared to when the same material is molded with an injection molding machine.

Polyvinyl chloride (PVC) compositions and PVC blends have been traditionally used in the production of slush molded interior panels for motor vehicles. However, PVC compositions are facing resistance due to environmental concerns relating to their chlorine content. In addition, the plasticizers required in PVC compositions to provide desired flexibility have been found to have the negative effect of fogging of the wind screen of the vehicles into which slush molded layers are incorporated. PVC also tends to make the molded part become brittle at low temperatures. Alternative thermoplastic materials that have been identified for slush molding include thermoplastic polyurethane (TPU) compositions, thermoplastic vulcanisates based on polyolefins (TPV), and elastomer compositions based on block copolymers of conjugated dienes and styrenes. Unfortunately, with these alternative materials, it has proved difficult to obtain the desired physical properties in the slush molded layer at a competitive cost.

A promising alternative to PVCs for use in slush molding is polyester elastomer. The slush molding of polyester elastomers having hard polybutylene terephthalate (PBT) segments and an aliphatic polyether soft segment such as polytetramethylene glycol is disclosed in EP 723844 A1. The slush molding of polyester elastomers having a PBT hard segment and a polyether soft segment derived from poly(propylene oxide) diol is disclosed in WO 03/051664. There is still a need for polyester elastomer slush molded layers having improved physical properties. Specifically, there is a need for polyester elastomer slush molded layers that are resilient, do not crack, and do not discolor even after extended periods of aging at elevated temperatures and exposures to ultraviolet radiation. There is a further need for polyester elastomer slush molded layers that do not suffer from the problem of blooming where composition components migrate to the surface of the molded layer and react so as to leave a detectable blotch, stain or slick area on the surface. There is also a need for polyester elastomer slush molded layers that are resistant to abrasion and associated discoloration such as scuff marks.

### Test Methods

In the description and the examples that follow, the following test methods were employed to determine various reported characteristics and properties. ISO refers to the International Organization for Standardization. In order to gauge the performance of a polymer material in a slush molded article, it is important to test the performance of a material in the form of slush molded samples.

Abrasion Resistance of slush molded articles was measured according to a dry crockmeter test which is designed to measure the abrasion resistance of slush molded articles. According to this test, a slush molded layer was rubbed with a circular white piece of cotton cloth defined in ISO105-F09 having a diameter of about 15 mm. The rubbing motion was reciprocal and linear over a stroke of about 100 mm, a load of about 9 Newtons, for 100 cycles in dry contact. The test was repeated with a least 3 replicates. The color change of the plastic surface was evaluated using a gray scale for assessing staining according to IS0105-A02. The color change of the white fabric was evaluated using a gray scale for assessing staining according to ISO105-A03. A result of 1 corresponds to the highest change of color while a result of 5 means no visible color change.

In a related test, the abrasion test process above was applied to the textured surface of a slush molded article and the color change of the surface subject to the abrasion was closely monitored. The number of strokes were counted between the start of the abrasion process and when there was sufficient color change on the surface subject to abrasion such that the gray scale rating according to IS0105-A02 dropped to a 4 rating. A higher number of strokes is indicative of greater resistance to abrasion.

Surface Oily Deposit was evaluated when the slush molded article was cool. The untextured back side of the slush molded article, that was in contact with the hot air of the oven during the molding process, was assessed. The degree of deposit was visually assessed using a linear scale where 4 corresponds to a good surface having no visible oily deposit, 3 corresponds to an acceptable surface having a barely perceivable visable oily deposit, 2 corresponds to a passable surface with minor visible oily deposit, and 1 corresponds to a poor surface with significant visible oily deposit and a very oily touch.

### DETAILED DESCRIPTION

According to the present invention, there is provided a slush molded layer comprised of a copolyether ester elastomer as a major component, a first siloxane from the group of carboxy-functional polysiloxanes and alkyl aryl polysiloxanes, a second siloxane that is different from the first siloxane, the second siloxane being selected from the group of high molecular weight polysiloxanes with a molecular weight greater than 100,000, carboxy-functional polysiloxanes and alkyl aryl polysiloxanes, and an antioxidant. According to a preferred embodiment of the invention, the slush molded layer is comprised of at least 80 weight percent of copolyether ester elastomer. According to another preferred embodiment of the invention, the first and second siloxanes together comprise from 0.1 to 8 weight percent of the slush molded layer. A preferred alkyl aryl polysiloxane is a branched aryl alkyl ether polysiloxane.

Copolyester elastomers are block copolyesters having hard polyester segments and soft segments of a flexible polymer that is a substantially amorphous polymer with a glass-transition temperature Tg of below 0 degrees C. Preferred copolyetherester(s) (also herein referred to as copolyetherester elastomers or copolyetherester polymers) are now described.

In a preferred embodiment, the copolyetherester elastomer(s) have a multiplicity of recurring long-chain ester units and short-chain ester units joined head-to-tail through ester linkages, the long-chain ester units being represented by the formula: 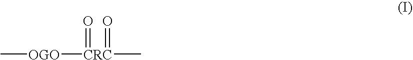
said short-chain ester units being represented by the formula: 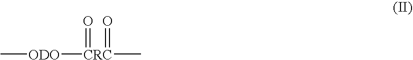
wherein
G is a divalent radical remaining after the removal of terminal hydroxyl groups from a poly(alkylene oxide)glycol having an average molecular weight of about 400-3500;
R is a divalent radical remaining after removal of carboxyl groups from a dicarboxylic acid having a molecular weight less than about 300;
D is a divalent radical remaining after removal of hydroxyl groups from a diol having a molecular weight less than about 250;
wherein said copolyetherester(s) contain from about 20 to about 99 weight percent short-chain ester units.

As used herein, the term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxy groups and having a molecular weight of from about 400 to about 3500, particularly from about 600 to about 2300. Preferred poly(alkylene oxide) glycols include poly(tetramethylene oxide) glycol, poly(trimethylene oxide) glycol, poly(propylene oxide) glycol, poly(ethylene oxide glycol, copolymer glycols of these alkylene oxides, and block copolymers such as ethylene oxide-capped poly(propylene oxide) glycol. Mixtures of two or more of these glycols can be used.

The term “short-chain ester units” as applied to units in a polymer chain of the copolyetheresters refers to low molecular weight compounds or polymer chain units having molecular weights less than about 550. They are made by reacting a low molecular weight diol or a mixture of diols (MW below about 250) with a dicarboxylic acid to form ester units represented by Formula (II) above.

Included among the low molecular weight diols which react to form short-chain ester units suitable for use for preparing copolyetheresters are acyclic, alicyclic and aromatic dihydroxy compounds. Preferred compounds are diols with 2-15 carbon atoms such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, etc. Especially preferred diols are aliphatic diols containing 2-8 carbon atoms, most especially 1,4-butanediol. Included among the bisphenols which can be used are bis(p-hydroxy)diphenyl, bis(p-hydroxyphenyl)methane, and bis(p-hydroxyphenyl)propane. Equivalent ester-forming derivatives of diols are also useful (e.g., ethylene oxide or ethylene carbonate can be used in place of ethylene glycol or resorcinol diacetate can be used in place of resorcinol).

The term “low molecular weight diols” as used herein should be construed to include such equivalent ester-forming derivatives; provided, however, that the molecular weight requirement pertains to the diol and not to its derivatives.

Dicarboxylic acids which are reacted with the foregoing long-chain glycols and low molecular weight diols to produce the copolyetheresters are aliphatic, cycloaliphatic or aromatic dicarboxylic acids of a low molecular weight, i.e., having a molecular weight of less than about 300. The term “dicarboxylic acids” as used herein includes acid equivalents of dicarboxylic acids having two functional carboxyl groups which perform substantially like dicarboxylic acids in reaction with glycols and diols in forming copolyetherester polymers. These equivalents include esters and ester-forming derivatives, such as acid halides and anhydrides. The molecular weight requirement pertains to the acid and not to its equivalent ester or ester-forming derivative. Thus, an ester of a dicarboxylic acid having a molecular weight greater than 300 or an acid equivalent of a dicarboxylic acid having a molecular weight greater than 300 are included provided the acid has a molecular weight below about 300. The dicarboxylic acids can contain any substituent groups or combinations which do not substantially interfere with the copolyetherester polymer formation and use of the polymer in the compositions of this invention.

The term “aliphatic dicarboxylic acids”, as used herein, means carboxylic acids having two carboxyl groups each attached to a saturated carbon atom. If the carbon atom to which the carboxyl group is attached is saturated and is in a ring, the acid is cycloaliphatic. Aliphatic or cycloaliphatic acids having conjugated unsaturation often cannot be used because of homopolymerization. However, some unsaturated acids, such as maleic acid, can be used.

Aromatic dicarboxylic acids, as the term is used herein, are dicarboxylic acids having two carboxyl groups attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—.

Representative aliphatic and cycloaliphatic acids which can be used are sebacic acid, 1,3-cyclohexane dicarboxylic acid, 1,4-cyclohexane dicarboxylic acid, adipic acid, glutaric acid, 4-cyclohexane-1,2-dicarboxylic acid, 2-ethylsuberic acid, cyclopentanedicarboxylic acid decahydro-1,5-naphthylene dicarboxylic acid, 4,4,′-bicyclohexyl dicarboxylic acid, decahydro-2,6-naphthylene dicarboxylic acid, 4,4,′-methylenebis(cyclohexyl) carboxylic acid, 3,4-furan dicarboxylic acid. Preferred acids are cyclohexane-dicarboxylic acids and adipic acid.

Representative aromatic dicarboxylic acids include phthalic, terephthalic and isophthalic acids, bibenzoic acid, substituted dicarboxy compounds with two benzene nuclei such as bis(p-carboxyphenyl)methane, p-oxy-1,5-naphthalene dicarboxylic acid, 2,6-naphthalene dicarboxylic acid, 2,7-naphthalene dicarboxylic acid, 4,4,′-sulfonyl dibenzoic acid and C₁-C₁₂ alkyl and ring substitution derivatives thereof, such as halo, alkoxy, and aryl derivatives. Hydroxyl acids such as p-(beta-hydroxyethoxy)benzoic acid can also be used providing an aromatic dicarboxylic acid is also present.

Aromatic dicarboxylic acids are a preferred class for preparing the copolyetherester polymers useful for this invention. Among the aromatic acids, those with 8-16 carbon atoms are preferred, particularly terephthalic acid alone or with a mixture of phthalic and/or isophthalic acids.

The copolyetheresters preferably contain about 20-99 weight percent short-chain ester units corresponding to Formula (II) above, the remainder being long-chain ester units corresponding to Formula (I) above. The copolyetheresters more preferably contain about 20-60, and even more preferably about 30-50, weight percent short-chain ester units the remainder being long-chain ester units. In general, as percent short-chain ester units in the copolyetherester are increased, the polymer has a higher tensile strength and modulus, and the hardness increases. Most preferably, at least about 70% of the groups represented by R in Formulae (I) and (II) above are 1,4-phenylene radicals and at least about 70% of the groups represented by D in Formula (II) above are 1,4-butylene radicals and the sum of the percentages of R groups which are not 1,4-phenylene radicals and D groups which are not 1,4-butylene radicals does not exceed 30%. If a second dicarboxylic acid is used to make the copolyetherester, isophthalic acid is the acid of choice and if a second low molecular weight diol is used, 1,4-butenediol or hexamethylene glycol are the diols of choice.

A blend or mixture of two or more copolyetherester elastomers can be used. The copolyetherester elastomers used in the blend need not on an individual basis come within the values disclosed hereinbefore for the elastomers. However, the blend of two or more copolyetherester elastomers must conform to the values described herein for the copolyetheresters on a weighted average basis. For example, in a mixture that contains equal amounts of two copolyetherester elastomers, one copolyetherester can contain 60 weight percent short-chain ester units and the other copolyetherester can contain 30 weight percent short-chain ester units for a weighted average of 45 weight percent short-chain ester units.

Preferably, the copolyetherester elastomers are prepared from esters or mixtures of esters of terephthalic acid and isophthalic acid, 1,4-butanediol and poly(tetramethylene ether)glycol or ethylene oxide-capped polypropylene oxide glycol, or are prepared from esters of terephthalic acid, e.g. dimethylterephthalate, 1,4-butanediol and poly(ethylene oxide)glycol. More preferably, the copolyetherester elastomers are prepared from esters of terephthalic acid, e.g. dimethylterephthalate, 1,4-butanediol and poly(tetramethylene ether)glycol.

The dicarboxylic acids or their derivatives and the polymeric glycol are preferably incorporated into the final product in the same molar proportions as are present in the reaction mixture. The amount of low molecular weight diol actually incorporated corresponds to the difference between the moles of diacid and polymeric glycol present in the reaction mixture. When mixtures of low molecular weight diols are employed, the amounts of each diol incorporated is largely a function of the amounts of the diols present, their boiling points, and relative reactivities. The total amount of glycol incorporated is still the difference between moles of diacid and polymeric glycol.

The copolyetherester elastomers described herein can be made conveniently by a conventional ester interchange reaction. A preferred procedure involves heating the ester of an aromatic acid, e.g., dimethyl ester of terephthalic acid, with the poly(alkylene oxide)glycol and a molar excess of the low molecular weight diol, 1,4-butanediol, in the presence of a catalyst at 150°-160° C., followed by distilling off methanol formed by the interchange reaction. Heating is continued until methanol evolution is complete. Depending on temperature, catalyst and glycol excess, this polymerization is complete within a few minutes to a few hours. This product results in the preparation of a low molecular weight prepolymer which can be carried to a high molecular weight copolyetherester by the procedure described below. Such prepolymers can also be prepared by a number of alternate esterification or ester interchange processes; for example, the long-chain glycol can be reacted with a high or low molecular weight short-chain ester homopolymer or copolymer in the presence of catalyst until randomization occurs. The short-chain ester homopolymer or copolymer can be prepared by ester interchange from either the dimethyl esters and low molecular weight diols as above, or from the free acids with the diol acetates. Alternatively, the short-chain ester copolymer can be prepared by direct esterification from appropriate acids, anhydrides or acid chlorides, for example, with diols or by other processes such as reaction of the acids with cyclic ethers or carbonates. Obviously the prepolymer might also be prepared by running these processes in the presence of the long-chain glycol.

The resulting prepolymer is then carried to high molecular weight by distillation of the excess of short-chain diol. This process is known as “polycondensation”. Additional ester interchange occurs during this distillation to increase the molecular weight and to randomize the arrangement of the copolyetherester units. Best results are usually obtained if this final distillation or polycondensation is run at less than 1 mm pressure and 240°-260° C. for less than 2 hours in the presence of antioxidants such as 1,6-bis-(3,5-di-tert-butyl-4-hydroxyphenol)propionamido]-hexane or 1,3,5-trimethyl-2,4,6-tris[3,5-ditertiary-butyl-4-hydroxybenzyl]benzene. Most practical polymerization techniques rely upon ester interchange to complete the polymerization reaction. In order to avoid excessive hold time at high temperatures with possible irreversible thermal degradation, it is advantageous to employ a catalyst for ester interchange reactions. While a wide variety of catalysts can be used, organic titanates such as tetrabutyl titanate used alone or in combination with magnesium or calcium acetates are preferred. Complex titanates, such as derived from alkali or alkaline earth metal alkoxides and titanate esters are also very effective. Inorganic titanates, such as lanthanum titanate, calcium acetate/antimony trioxide mixtures and lithium and magnesium alkoxides are representative of other catalysts which can be used.

Ester interchange polymerizations are generally run in the melt without added solvent, but inert solvents can be used to facilitate removal of volatile components from the mass at low temperatures. This technique is especially valuable during prepolymer preparation, for example, by direct esterification. However, certain low molecular weight diols, for example, butanediol, are conveniently removed during polymerization by azeotropic distillation. Other special polymerization techniques for example, interfacial polymerization of bisphenol with bisacylhalides and bisacylhalide capped linear diols, may be useful for preparation of specific polymers. Both batch and continuous methods can be used for any stage of copolyetherester polymer preparation. Polycondensation of prepolymer can also be accomplished in the solid phase by heating finely divided solid prepolymer in a vacuum or in a stream of inert gas to remove liberated low molecular weight diol. This method is believed to have the advantage of reducing degradation because it is used at temperatures below the softening point of the prepolymer where the degradation rate is much slower relative to the polymerization rate. The major disadvantage is the long time required to reach a given degree of polymerization.

The copolyester elastomer slush molded layer of the invention further comprises first and second siloxanes. According to the invention, the first siloxane is a carboxy-functional polysiloxanes or an alkyl aryl polysiloxane. According to the invention, the second siloxane is different from the first siloxane and is from the group of high molecular weight polysiloxanes with a molecular weight greater than 100,000, carboxy-functional polysiloxanes and an alkyl aryl polysiloxanes. The carboxy-functional polysiloxanes and alkyl aryl polysiloxanes are organo-modified polysiloxanes having an affinity for the copolyether ester elastomer such that these organo-modified polysiloxanes do not migrate to the surface in an amount that would cause the surface to become slick or oily. These organo-modified polysiloxanes provide ongoing surface abrasion resistance over extended periods of time. The high molecular weight polysiloxanes have a high percent of siloxane groups that enable them to provide good abrasion resistance for the slush molding layer. However because of their large size, the high molecular weight polysiloxanes do not readily migrate to the surface and leave an oily surface deposit, in particular during the moulding process. It has been found that by using two different polysiloxanes, it is possible to combine the contributions of the two siloxanes so as to obtain the desired level of abrasion resistance while avoiding the side effect of an oily surface of the slush molded article.

Organo-modified polysiloxane compounds are preferred and have been advantageously used in order to improve mold release and abrasion resistance properties of the copolyester elastomer slush molded layer. Examples of organo-modified polysiloxane compounds include carboxy-functional polysiloxanes and alkyl aryl polysiloxanes.

An example of a carboxy-functional polysiloxane is represented by the following formula: 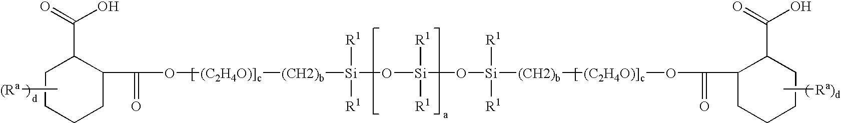
where
R₁=methyl group,
R^{a}═H or C₁₋₄ alkyl group,
a=about 20 to 30, b=3 to 10, c=0, and d=1.

Linear or branched alkyl aryl polysiloxanes have been found to be especially useful for improving the abrasion resistance of the copolyester elastomer slush molded layer of the invention. Such linear or branched alkyl aryl polysiloxanes have a level of compatibility with the copolyether-ester that greatly reduces blooming issues which could otherwise result in an oily surface. A type of alkyl aryl polysiloxane that is a polyether siloxane is represented by the formula (I): 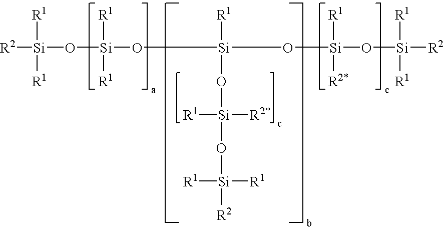
R¹ represents individually independent aliphatic or aromatic C₁₋₂₀-hydrocarbons,
R², R²* are equal or different with the following chemical structure: —(OAlk)_{d}—(O)ₖ—R³ with:

R³ represents H, optionally branched C₁₋₂₀— alkyl group, —(CH₂—CHR⁴)ₕ—(O)ₖ-Ph(R⁵)_{f},
R⁴ represents H, CH₃,
R⁵ represents optionally branched C₁₋₂₀-alkyl group, with
Alk: C₁₋₄-alkyl group,
Ph: Phenyl group.
a=0 to 500,
b=0 to 50,
c=0 to 50,
d=0 to 30,
f=0 to 4,
h=0 or 1
k=0 or 1
   with a proportion or Si atoms equal or greater than 5% of the total mass of the organo-modified siloxane described in this formula.

Another preferred alkyl aryl polysiloxanes is a branched alkyl aryl polysiloxane represented by the formula (II): 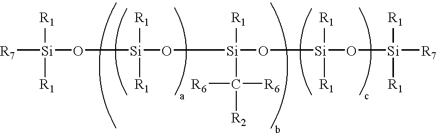
R₁ represents individually independent aliphatic or aromatic C₁₋₂₀-hydrocarbons,
R₆ represents individually independent aliphatic or aromatic C₁₋₂₀-hydrocarbons,
R₇ represents individually independent aliphatic or aromatic C₁₋₂₀-hydrocarbons,
R₂ has the following chemical structure: —(OAlk)_{d}—(O)ₑ—R₃ with
   R₃ represents H, optionally branched C₁₋₂₀-alkyl group, —(CH R₄)ᵣ—(O)_{g}—Ph—(R₅)ₕ,
   R₄ represents H, CH₃,
   R₅ represents optionally branched C₁₋₂₀-alkyl group,
   Alk: C₁₋₄-alkyl group,
   Ph: Phenyl group.
a=0 to 50,
b=0 to 50,
c=0 to 500,
d=0 to 30,
e=0 or 1,
f=0 to 1,
h=0 or 1

In one preferred branched alkyl aryl polysiloxane according to the above formula (II),
R₁═R₇=Me
R₆═R₄═H
R₂═R₃═(CHR₄)_{f}—(O)_{g}—Ph—(R₅)ₕ
with a=b 0, b=5, c=45, d=0, e=0, f=1, g=0, h=0

The high molecular weight polysiloxane with a molecular weight greater than 100,000 is preferably a very high molecular weight polysiloxane with a molecular weight in the range of from 100,000 to 2 million. More preferably, the high molecular weight polysiloxane is an ultra high molecular weight polysiloxane. A preferred ultra high molecular weight polysiloxane is polydimethyl siloxane with a molecular weight approaching or exceeding 1 million. Examples of suitable ultra high molecular weight polysiloxanes are MB50-010 and MB50-002 sold by Dow Corning. MB50-010 is a masterbatch of ultra high molecular weight siloxane polymer dispersed in a copolyether ester elastomer that is in a solid dry pellet form.

The copolyetherester elastomer slush molded layer of the invention also includes an antioxidant. According to a preferred embodiment of the invention, the antioxidant is a hindered phenol antioxidant, a thioether antioxidant, or more preferably a combination of the two. The thioether antioxidant is a divalent sulfur derivative and it acts as a peroxide decomposer. The combination of a hindered phenol antioxidant and a thioether antioxidant helps to protect the copolyetherester elastomer slush molded layer against physical property degradation when the layer is exposed to heat and ultraviolet light over extended periods of time. At the same time, it has been found that with this combination of antioxidants, the slush molded layer exhibits very low discoloration after extended exposure to heat or ultraviolet radiation. In a preferred embodiment of the invention, the copolyetherester elastomer slush molded layer of the invention is comprised of a composition that includes 0.1 to 4 weight percent of a hindered phenol antioxidant, and 0.05 to 3 weight percent of thioether antioxidant.

The hindered phenol antioxidant incorporated into the elastomer composition used to produce the slush molded layer of the invention is preferably a sterically hindered phenol antioxidant that contains at least one group of the formula: 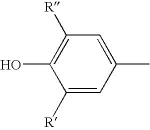
in which R′ is hydrogen, methyl or tert-butyl; and R″ is unsubstituted or substituted alkyl or substituted thioether. More preferably the sterically hindered phenol contains at least two groups according to this formula in which R′ is hydrogen, methyl or tert-butyl; and R″ is unsubstituted or substituted alkyl or substituted thioether.

Examples of sterically hindered phenols of this type are: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-i-butylphenol, 2,6-dicyclopentyl-4-methylphenol, 2-(.alpha.-methylcyclohexyl)-4,6-dimethylphenol, 2,6-dioctadecyl-4-methylphenol, 2,4,6-tricyclohexylphenol, 2,6-di-tert-butyl-4-methoxymethylphenol, 2,6-dinonyl-4-methylphenol, 2,6-di-tert-butyl-4-methoxyphenol, 2,5-di-tert-butylhydroquinone, 2,5-di-tert-amylhydroquinone, 2,6-diphenyl-4-octa-decyloxyphenol, 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 2,2′-methylenebis(6-tert-butyl-4-methylphenol), 2,2′-methylenebis(6-tert-butyl-4-ethylphenol), 2,2′-methylenebis[4-methyl-6-(.alpha.-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(.alpha.-methylbenzyl)-4-nonylphenol], 2,2′-methylenebis[6-(.alpha.alpha.-dimethylbenzyl)-4-nonyl-phenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-do-decylmercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl] terephthalate, 1,3,5-tris(3,5-di-tert-butyl-4-hydroxybenzyl)-2,4,6-trimethylbenzene, bis(3,5-di-tert-butyl-4-hydroxybenzyl) sulfide, isooctyl 3,5-di-tert-butyl-4-hydroxybenzylmercaptoacetate, bis(4-tert-butyl-3-hydroxy-2,6-dimethylbenzyl) dithioterephthalate, 1,3,5-tris(3,5-di-tert-butyl-4-hydroxybenzyl) isocyanurate, 1,3,5-tris(4-tert-butyl-3-hydroxy-2,6-dimethylbenzyl) isocyanurate, dioctadecyl 3,5-di-tert-butyl-4-hydroxybenzylphosphonate and the calcium salt of monoethyl 3,5-di-tert-butyl-4-hydroxybenzylphosphonate.

Preferred hindered phenol antioxidants for the slush molded layer of the invention are sterically hindered phenols containing at least the [3,5-di-tert-butyl-4-hydroxyphenyl] radical. Especially preferred sterically hindered phenol antioxidants include Tetrakis (methylene (3,5-di-tert-butyl-4-hydroxycinnamate) methane), 1,3,5-trimethyl-2,4,6-tris(3,5-di-tert-butyl-4-hydroxybenzyl) benzene, and N,N′-propane-1,3-diylbis [3-(3,5-di-tert-butyl-4-hydroxyphenyl) propionamide] and N,N′-hexamethylene bis [3,5-di-tert-butyl-4-hydroxy-hydrocinnamamide].

The thioether antioxidant is a thioether with at least one ester group, and preferably two ester groups, as for example dilaurylthiodipropionate, ditridecylthiodipropionate, or distearylthiodipropionate.

According to one preferred embodiment of the invention, hindered amine light stabilizers (HALS) may be included in the composition used to produce the slush molded layers of the invention so as to help the layer to resist photodegradation. Preferably the copolyester elastomer slush molded layer for the invention includes 0.1 to 5 weight percent of a hindered amine light stabilizer, and more preferably 0.1 to 2 weight percent HALS.

HALS mean compounds of the following general formulas and combinations thereof:

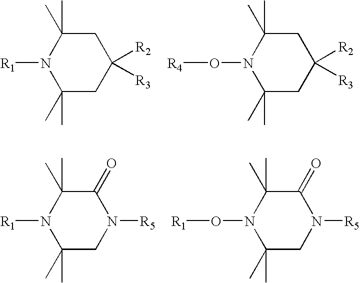

In these formulas, R₁ up to and including R₅ are independent substituents. Examples of suitable substituents are hydrogen, ether groups, ester groups, amine groups, amide groups, alkyl groups, alkenyl groups, alkynyl groups, aralkyl groups, cycloalkyl groups and aryl groups, in which the substituents in turn may contain functional groups; examples of functional groups are alcohols, ketones, anhydrides, imines, siloxanes, ethers, carboxyl groups, aldehydes, esters, amides, imides, amines, nitriles, ethers, urethanes and any combination thereof. A hindered amine light stabilizer may also form part of a polymer.

Preferably, the HALS compound is a compound derived from a substituted piperidine compound, in particular any compound derived from an alkyl-substituted piperidyl, piperidinyl or piperazinone compound, and substituted alkoxypiperidinyl compounds. Examples of such compounds are: 2,2,6,6-tetramethyl-4-piperidone; 2,2,6,6-tetrametyl-4-piperidinol; bis-(1,2,2,6,6-pentamethyl piperidyl)-(3′,5′-di-tert-butyl-4′-hydroxybenzyl)-butylmalonate; di-(2,2,6,6-tetramethyl-4-piperidyl)-sebacate (Tinuvin® 770); oligomer of N-(2-hydroxyethyl)-2,2,6,6-tetramethyl-4-piperidinol and succinic acid (Tinuvin® 622); oligomer of cyanuric acid and N,N-di(2,2,6,6-tetramethyl-4-piperidyl)-hexamethylene diamine; bis-(2,2,6,6-tetramethyl-4-piperidinyl)-succinate; bis-(1-octyloxy-2,2,6,6-tetramethyl-4-piperidinyl)-sebacate (Tinuvin® 123); bis-(1,2,2,6,6-pentamethyl-4-piperidinyl)-sebacate (Tinuvin® 765); tetrakis-(2,2,6,6-tetramethyl-4-piperidyl)-1,2,3,4-butane-tetracarboxylate; N,N′-bis-(2,2,6,6-tetramethyl-4-piperidyl)-hexane-1,6-diamine (Chimasorb® T5); N-butyl-2,2,6,6-tetramethyl-4-piperidinamine; 2,2′-[(2,2,6,6-tetramethyl-piperidinyl)-imino]-bis-[ethanol]; poly((6-morpholine-S-triazine-2,4-diyl)(2,2,6,6-tetramethyl-4-piperidinyl)-iminohexamethylene-(2,2,6,6-tetramethyl-4-piperidinyl)-imino) (Cyasorbe UV 3346); 5-(2,2,6,6-tetramethyl-4-piperidinyl)-2-cyclo-undecyl-oxazole) (Hostavin® N20); 1,1′-(1,2-ethane-di-yl)-bis-(3,3′,5,5′-tetramethyl-piperazinone); 8-acetyl-3-dothecyl-7,7,9,9-tetramethyl-1,3,8-triazaspiro(4,5)decane-2,4-dione; polymethylpropyl-3-oxy-[4(2,2,6,6-tetramethyl)-piperidinyl)-siloxane (Uvasil® 299); 1,2,3,4-butane-tetracarboxylic acid-1,2,3-tris(1,2,2,6,6-pentamethyl-4-piperidinyl)-4-tridecylester; copolymer of alpha-methylstyrene-N-(2,2,6,6-tetramethyl-4-piperidinyl) maleimide and N-stearyl maleimide; 1,2,3,4-butanetetracarboxylic acid, polymer with beta,beta,beta1,beta1-tetramethyl-2,4,8,10-tetraoxaspiro[5.5]undecane-3,9-diethanol, 1,2,2,6,6-pentamethyl-4-piperidinyl ester (Mark® LA63); 2,4,8,10-tetraoxaspiro[5.5]undecane-3,9-diethanol,beta,beta,beta′,beta′-tetramethyl-polymer with 1,2,3,4-butanetetracarboxylic acid, 2,2,6,6-tetramethyl-4-piperidinyl ester (Mark® LA68); D-glucitol, 1,3:2,4-bis-O-(2,2,6,6-tetramethyl-4-piperidinylidene)-(HALS 7); oligomer of 7-oxa-3,20-diazadispiro[5.1.11.2]-heneicosan-21-one,2,2,4,4-tetramethyl-20-(oxiranylmethyl)-(Hostavin® N30); propanedioic acid, [(4-methoxyphenyl)methylene]-,bis(1,2,2,6,6-pentamethyl-4-piperidinyl) ester (Sanduvor® PR 31); formamide, N,N′-1,6-hexanediylbis[N-(2,2,6,6-tetramethyl-4-piperidinyl (Uvinul® 4050H). 1,3,5-triazine-2,4,6-triamine, N,N′″-[1,2-ethanediylbis [[[4,6-bis[butyl(1,2,2,6,6-pentamethyl-4-piperidinyl)amino]-1,3,5-triazine-2-yl]imino]-3,1-propanediyl]]-bis[N′,N″-dibutyl-N′,N″-bis(1,2,2,6,6-pentamethyl-4-piperidinyl) (Chimassorbe 119); poly[[6-[(1,1,3,33-tetramethylbutyl) amino]-1,3,5-triazine-2,4-diyl][(2,2,6,6-tetramethyl-4-peperidinyl)-imino]-1,6-hexanediyl [(2,2,6,6-tetramethyl-4-piperidinyl)imino]] (Chimassorb® 944); 1,5-dioxaspiro (5,5) undecane 3,3-dicarboxylic acid, bis(2,2,6,6-tetramethyl-4-peridinyl) ester (Cyasorb® UV-500); 1,5-dioxaspiro (5,5) undecane 3,3-dicarboxylic acid, bis (1,2,2,6,6-pentamethyl-4-peridinyl) ester (Cyasorb® UV-516); N-2,2,6,6-tetramethyl-4-piperidinyl-N-amino-oxamide; 4-acryloyloxy-1,2,2,6,6-pentamethyl-4-piperidine. 1,5,8,12-tetrakis[2′,4′-bis(1″,2″,2″,6″,6″-pentamethyl-4″-piperidinyl(butyl)amino)-1′,3′,5′-triazine-6′-yl]-1,5,8,12-tetraazadodecane. HALS PB-41 (Clariant Huningue S. A.); Nylostab® S-EED (Clariant Huningue S. A.); 3-dodecyl-1-(2,2,6,6-tetramethyl-4-piperidyl)-pyrrolidin-2,5-dione; Uvasorb® HA88; 1,1′-(1,2-ethane-di-yl)-bis-(3,3′,5,5′-tetra-methyl-piperazinone) (Good-rite® 3034); 1,1′1″-(1,3,5-triazine-2,4,6-triyltris ((cyclohexylimino)-2,1-ethanediyl)tris(3,3,5,5-tetramethylpiperazinone) (Good-rite® 3150); 1,1′,1″-(1,3,5-triazine-2,4,6-triyltris((cyclohexylimino)-2,1-ethanediyl)tris(3,3,4,5,5-tetramethylpiperazinone) (Good-rite® 3159).

According to a more preferred embodiment of the invention, a high-molecular weight oligomeric HALS is used in the copolyester elastomer slush molded layer of the invention. Oligomeric or polymeric HALS compounds have a molecular weight of more than 1000, and preferably more than 2000. Examples of commercial oligomeric HALS include Tinuvin® 622, Uvasil® 299, Cyasorb® UV 3346, Cyasorb® UV 3529 and Chimassorb® 944. Especially preferred high-molecular weight oligomeric HALS used in the copolyester elastomer slush molded layer of the invention are secondary oligomeric HALS. The addition of 0.1 to 4 weight percent of these secondary oligomeric HALS in the slush molded layer of the invention has been found to be especially beneficial in reducing blooming of acid oligomers of copolyether-ester.

Other additives such UV stabilizers, color concentrates, pigments, mineral and glass fillers or reinforcements may be added to the formulation used to produce the slush molded layer of the invention. Additional UV stabilizers such as UV screeners can be added to the formulation. Various conventional fillers can be added to the copolyetheresters usually in amounts of from about 1-20 percent by weight based on the total weight of the copolyetherester(s) and fillers only. Examples of such fillers include clay, talc, alumina, carbon black and silica. In general, these additives have the effect of increasing the modulus at various elongations.

The invention is further illustrated by the following examples. It will be appreciated that the examples are for illustrative purposes only and are not intended to limit the invention as described above. Modification of detail may be made without departing from the scope of the invention.

### EXAMPLES

In the Examples below, one more of the following components were compounded in a twin screw extruder. In the compounding operation, the antioxidants, stabilizers, and other additives were mixed into the copolyether-ester thermoplastic resin. The extruded polymer strand was cut into pellets. The pellets were cooled with liquid nitrogen and ground in a high speed grinder to obtain a powder with a mean particle size of about 300 to 400 microns.

a) Copolyester Elastomer

Copolyester A is a copolyether ester containing about 35 weight percent of 1,4-butylene terephthalate short-chain ester units and about 66 weight percent of polytetramethylene ether glycol long-chain ester units with a molecular weight of about 2000. Copolyester A has a melting point of about 193° C. and a melt flow rate of about 20 g/10 minutes measured at a temperature of 220° C. under a 2.16 kg load.

Copolyester B is a copolyether ester containing about 49 weight percent of 1,4-butylene terephthalate and 1,4-butylene isophthalate short-chain ester units and about 51 weight percent of polytetramethylene ether glycol long-chain ester units with a molecular weight of about 1000. Copolyester B has a melting point of about 150° C. and a melt flow rate of about 5 g/10 minutes measured at a temperature of 190° C. under a 2.16 kg load.

Copolyester C is a copolyether ester containing about 70 weight percent of 1,4-butylene terephthalate short-chain ester units and about 30 weight percent of polytetramethylene ether glycol long-chain ester units with a molecular weight of about 1000. Copolyester C has a melting point of about 211° C. and a melt flow rate of about 8 g/10 minutes measured at a temperature of 230° C. under a 2.16 kg load.

b) Antioxidant

Antioxidant A: Tetrakis (methylene (3,5-di-tert-butyl-4-hydroxycinnamate) methane), a sterically hindered phenol antioxidant having a melting point of 110-125° C. and a molecular weight of 1180 g/mol.

Antioxidant B: 1,3,5-trimethyl-2,4,6-tris(3,5-di-tert-butyl-4-hydroxybenzyl) benzene, a sterically hindered phenol antioxidant having a melting point of 241-245° C. and a molecular weight of 595 g/mol.

Antioxidant C: Benzene Propanamide, N,N′-1-6 hexanediylbis [3-5-bis(1,1-dimethyl)-4-hydroxy], a sterically hindered phenol antioxidant having a melting point of 156-161° C. and a molecular weight of 637 g/mol.

Antioxidant D: N,N′-propane-1,3-diylbis [3-(3,5-di-tert-butyl-4-hydroxyphenyl) propionamide], a sterically hindered phenol antioxidant having a melting point of 173-179° C. and a molecular weight of 595 g/mol.

Antioxidant E: Di lauryl thio di propionate (DLTDP), a thioether stabilizer having a melting point of 39-41° C. and a molecular weight of 515 g/mol.

C) Hindered Amine Light Stabilizer

HALS A: Poly [[6-[(1,1,3,3-tetramethylbutyl) amino]-1,3,5-triazine-2,4-diyl][(2,2,6,6-tetramethyl-4-piperidinyl)-imino]-1,6-hexanediyl [(2,2,6,6-tetramethyl-4-piperidinyl)imino]]; an oligomeric HALS having a melting range of 100-135° C. and a molecular weight of 2000-3100 g/mol.

d) Polysiloxane Compound

Siloxane A: a linear aryl alkyl polyether polysiloxane having a molecular weight of about 3000 g/mol, according to the aryl alkyl polyether polysiloxane formula (I) above where
R¹═CH₃,
R²═R³=—(CH₂—CHR⁴)ₕ—(O)ₘ—Ph(R⁵)_{f}
R⁴═CH₃,
R⁵═C₉ alkyl,
with a=29, b=0, c=0, e=0, f=1, h=1, m=1

Siloxane B: a carboxy-functional polysiloxane sold by Degussa Goldschmidt under the tradename Tegomer® C-Si2342.

Siloxane C: DOW Corning PDMS MB50-010, an ultra high molecular weight polydimethylsiloxane with a molecular weight of around 1 million that is dispersed in a copolyether ester elastomer at a siloxane content of 50%.

Siloxane D: a branched aryl alkyl polysiloxane having a molecular weight of about 4300 g/mol, according to the aryl alkyl polysiloxane formula (II) above where
R₁═R₇=Me
R₆═R₄═H
R₂═R₃═(CHR₄)—(O)_{g}-Ph-(R₅)ₕ
Where a=0, b=5, c=45, d=0, e=0, f=1, g=0, h=0

A mold for producing a slush molded layer was preheated to a temperature of 280° C. The mold was then connected to a box containing the thermoplastic resin in powder form. The assembly of box and mold was rotated in order to disperse the particles over the hot surface of the tool. The thermoplastic resin powder melted to form a layer or skin over the mold surface. The mold was then reheated to about 240° C. for about 3 minutes to complete the formation of the slush molded layer. The mold was then cooled with air during which time the thermoplastic material solidified. The solidified thermoplastic layer was subsequently removed from the mold and the properties were measured according to the test methods described above. The compositions and properties of the slush molded samples are reported in the table below.

| | Example No. | | | | | | | | |
|---|---|---|---|---|---|---|---|---|---|
| | A | B | C | D | E | F | G | H | I |
| Copolyester A | 89.78 | 89.38 | 88.38 | 88.48 | 88.08 | 87.39 | 88.28 | 87.89 | 87.37 |
| Copolyester B | 7.73 | 7.73 | 7.73 | 7.73 | 7.73 | 7.73 | 7.73 | 7.73 | 7.73 |
| Copolyester C | | | | 0.20 | 0.20 | 1.00 | | | 0.25 |
| Antioxidant A | 0.25 | 0.25 | 0.25 | 0.25 | 0.25 | 0.25 | 0.25 | 0.25 | 0.25 |
| Antioxidant B | 0.20 | 0.20 | 0.20 | 0.20 | 0.20 | 0.20 | 0.20 | 0.20 | 0.20 |
| Antioxidant C | 0.15 | 0.15 | 0.14 | 0.15 | 0.14 | 0.14 | 0.14 | 0.14 | 0.14 |
| Antioxidant D | 0.15 | 0.15 | 0.14 | 0.15 | 0.14 | 0.14 | 0.14 | 0.14 | 0.14 |
| Antioxidant E | 0.20 | 0.20 | 0.20 | 0.20 | 0.20 | 0.20 | 0.20 | 0.20 | 0.20 |
| HALS A | 0.30 | 0.30 | 0.30 | 0.30 | 0.30 | 0.30 | 0.30 | 0.30 | 0.30 |
| Siloxane A | | | 1.00 | 0.90 | 0.90 | | | | |
| Siloxane B | | 0.40 | 0.40 | | 0.40 | 0.40 | | 0.40 | 0.40 |
| Siloxane C | | | | 0.20 | 0.20 | 1.00 | | | 0.25 |
| Siloxane D | | | | | | | 1.50 | 1.50 | 1.50 |
| Carbon Black | 1.25 | 1.25 | 1.25 | 1.25 | 1.25 | 1.25 | 1.25 | 1.25 | 1.25 |
| PROPERTIES | | | | | | | | | |
| Abrasion | 1 | 1 | 1-2 | 1-2 | 2 | 5 | 2 | 5 | 5 |
| Resistance | | | | | | | | | |
| Rating | | | | | | | | | |
| Abrasion strokes | 8 | 15 | 15 | 30 | 60 | 110 | 80 | 465 | 500 |
| until 4 Rating | | | | | | | | | |
| Surface Oily | 4 | 4 | 4 | 2 | 2 | 1 | 3 | 3 | 2 |
| Deposit Rating | | | | | | | | | |

The data in the table above shows that abrasion resistance of a slush molded article is improved with addition of a polysiloxane. However, the polysiloxane must be selected carefully in order to avoid surface oily deposits. It is the combination of an alkyl aryl polysiloxane (Siloxane A and/or Siloxane D) and a second branched aryl alkyl polysiloxane that was found to achieve excellent abrasion resistance with a barely perceivable oily surface deposit (Example H).

1. A slush molded layer comprised of:
copolyether ester elastomer as a major component;
a first siloxane from the group of carboxy-functional polysiloxanes and alkyl aryl polysiloxanes;
a second siloxane that is different from the first siloxane, said second siloxane being from the group of a high molecular weight polysiloxanes with a molecular weight greater than 100,000, carboxy-functional polysiloxanes, and alkyl aryl polysiloxanes; and
an antioxidant.

2. The slush molded layer of claim 1 comprised of at least 80 weight percent of copolyether ester elastomer.

3. The slush molded layer of claim 2 wherein said first and second siloxanes together comprise from 0.1 to 8 weight percent of the slush molded layer.

4. The slush molded layer of claim 1, wherein the first siloxane comprises an alkyl aryl polysiloxane.

5. The slush molded layer of claim 4, wherein the first siloxane comprises an alkyl aryl ether polysiloxane.

6. The slush molded layer of claim 5, wherein the first siloxane comprises an alkyl aryl ether polysiloxane having the formula 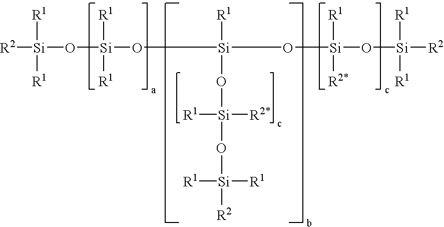
wherein
R¹ represents individually independent aliphatic or aromatic C₁₋₂₀-hydrocarbons,
R², R²* are equal or different with the following chemical structure: —(OAlk)_{d}—(O)ₖ—R³ with:
R³ represents H, optionally branched C₁₋₂₀— alkyl group, —(CH₂—CHR⁴)ₕ—(O)ₖ—Ph(R⁵)_{f},
R⁴ represents H, CH₃,
R⁵ represents optionally branched C₁₋₂₀-alkyl group, with
Alk: C₁₋₄-alkyl group,
Ph: Phenyl group.
a: 0 to 500,
b: 0 to 50,
c: 0 to 50,
d: 0 to 30,
f: 0 to 4,
h: 0 or 1
k: 0 or 1
where the proportion or Si atoms is equal to or greater than 5% of the total mass of the first siloxane.

7. The slush molded layer of claim 1, wherein the first siloxane comprises a carboxy-functional polysiloxane.

8. The slush molded layer of claim 7, wherein the carboxy-functional siloxane is represented by the formula: 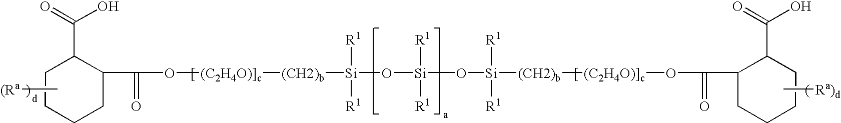
where R¹ represents a methyl group, R^{a} represents H or a C₁₋₄ alkyl group, and
a=about 20 to 30, b=3 to 10, c=0, and d=1.

9. The slush molded layer of claim 8, wherein the second siloxane comprises an alkyl aryl polysiloxane.

10. The slush molded layer of claim 1, wherein the second siloxane is an ultra high molecular weight polysiloxane having a molecular weight of greater than about 1 million.

11. The slush molded layer of claim 1, wherein the second siloxane is an ultra high molecular weight polydimethylsiloxane.

12. The slush molded layer of claim 4, wherein the second siloxane comprises a different alkyl aryl polysiloxane than the first alkyl aryl polysiloxane.

13. The slush molded layer of claim 12, wherein the second siloxane comprises a branched alkyl aryl polysiloxane.

14. The slush molded layer of claim 13, wherein the second siloxane comprises a branched alkyl aryl polysiloxane having the formula 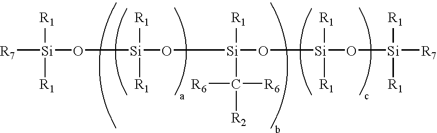
R₁ represents individually independent aliphatic or aromatic C₁₋₂₀-hydrocarbons,
R₆ represents individually independent aliphatic or aromatic C₁₋₂₀-hydrocarbons,
R₇ represents individually independent aliphatic or aromatic C₁₋₂₀-hydrocarbons,
R₂ has the following chemical structure: —(OAlk)_{d}—(O)ₑ—R₃ where:
R₃ represents H, optionally branched C₁₋₂₀— alkyl group, —(CHR₄)_{f}—(O)_{g}—Ph—(R₅)ₕ,
R₄ represents H or CH₃,
R₅ represents a C₁₋₂₀-alkyl group,
Alk represents a C₁₋₄-alkyl group,
Ph represents a Phenyl group and
a=0 to 50,
b=0 to 50,
c=0 to 500,
d=0 to 30,
e=0 or 1,
f=0 to 1,
h=0 or 1

15. The slush molded layer of claim 1, further comprising a hindered amine light stabilizer.

16. The slush molded layer of claim 15, wherein the hindered amine light stabilizer is an oligomeric hindered amine light stabilizer having a molecular weight greater than 1000/mol.

17. The slush molded layer of claim 15, wherein the hindered amine light stabilizer is an oligomeric hindered amine light stabilizer having a molecular weight greater than 2000/mol.

18. The slush molded layer of claim 1, wherein the antioxidant includes a sterically hindered phenol antioxidant.

19. The slush molded layer of claim 18, wherein the sterically hindered phenol antioxidant contains the [3,5-di-tert-butyl-4-hydroxyphenyl] radical.

20. The slush molded layer of claim 18, wherein the sterically hindered phenol antioxidant contains at least two [3,5-di-tert-butyl-4-hydroxyphenyl] radicals.

21. The slush molded layer of claim 18, wherein the sterically hindered phenol antioxidant is selected from the group of Tetrakis (methylene (3,5-di-tert-butyl-4-hydroxycinnamate) methane); 1,3,5-trimethyl-2,4,6-tris(3,5-di-tert-butyl-4-hydroxybenzyl) benzene; N,N′-propane-1,3-diylbis [3-(3,5-di-tert-butyl-4-hydroxyphenyl) propionamide]; and Pentaerythritol Tetrakis (3-(3,5-di-tert-butyl-4-hydroxyphenyl)propionate).

22. The slush molded layer of claim 18, wherein antioxidant further includes a thioether antioxidant.

23. The slush molded layer of claim 22, comprising 0.1 to 4 weight percent of hindered phenol antioxidant, and 0.05 to 3 weight percent of thioether antioxidant.

24. The slush molded layer of claim 22, wherein the thioether anitoxidant is didodecyl 3,3′-thiodiproprionate.

25. The slush molded layer of claim 1 further comprising 1 to 20 weight percent of filler material selected from the group of clay talc, alumina and silica.

26. The slush molded layer of claim 1 comprising at least 80 weight percent of copolyether ester elastomer, 0.1 to 8 weight percent of two or more polysiloxanes, 0.1 to 4 weight percent of hindered phenol antioxidant, 0.05 to 3 weight percent of thioether antioxidant, and 0.05 to 5 weight percent of a hindered amine light stabilizer.

27. The slush molded layer of claim 25, comprising 0.05 to 3 weight percent of a carboxy-functional polysiloxane and 0.3 to 5 weight percent of a branched alkyl aryl polysiloxane having the formula 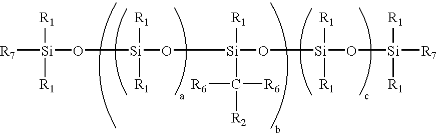
R₁ represents individually independent aliphatic or aromatic C₁₋₂₀-hydrocarbons,
R₆ represents individually independent aliphatic or aromatic C₁₋₂₀-hydrocarbons,
R₇ represents individually independent aliphatic or aromatic C₁₋₂₀-hydrocarbons,
R₂ has the following chemical structure: —(OAlk)_{d}—(O)ₑ—R₃ where:
R₃ represents H, optionally branched C₁₋₂₀-alkyl group, —(CHR₄)_{f}—(O)_{g}—Ph—(R₅)ₕ,
R₄ represents H or CH₃,
R₅ represents a C₁₋₂₀-alkyl group,
Alk represents a C₁₋₄-alkyl group,
Ph represents a Phenyl group and
a=0 to 50,
b=0 to 50,
c=0 to 500,
d=0 to 30,
e=0 or 1,
f=0 to 1,
h=0 or 1
